(19) United States
(12) Patent Application Publication
(10) Pub. No.: US 2017/0222463 A1
(43) Pub. Date: Aug. 3, 2017

(54) DUTY CYCLE CONTROL FOR CHARGING A BATTERY

(71) Applicant: QUALCOMM Incorporated, San Diego, CA (US)

(72) Inventors: Stuart PULLEN, Raleigh, NC (US); Steve HAWLEY, Emerald Hills, CA (US); Thomas O'BRIEN, Powell, OH (US)

(21) Appl. No.: 15/270,847

(22) Filed: Sep. 20, 2016

Related U.S. Application Data
(60) Provisional application No. 62/289,896, filed on Feb. 1, 2016.

(51) Int. Cl. H02J 7/00

(52) U.S. Cl. CPC H02J 7/0072

(57) ABSTRACT

A battery charging implementation improves the charging time (e.g., deliver a maximum or improved charge while minimizing or reducing power loss on the mobile device) by regulating a charging device duty cycle (e.g., buck duty cycle) of a switching regulator/converter (e.g., buck regulator) to a narrow range. An input voltage of a battery charging circuit is dynamically adjusted to maintain a duty cycle within a predetermined range. A battery is then charged in accordance with an output voltage of the battery charging circuit resulting from the adjusted duty cycle.

### CROSS-REFERENCE TO RELATED APPLICATION

The present application claims the benefit of U.S. Provisional Patent Application No. 62/289,896, filed on Feb. 1, 2016, and titled “DUTY CYCLE CONTROL FOR CHARGING A BATTERY,” and U.S. Provisional Patent Application No. 62/289,873, filed Feb. 1, 2016, the disclosure of which is expressly incorporated by reference herein in its entirety.

### TECHNICAL FIELD

The present disclosure relates to electronic circuits, systems and apparatuses, and in particular, to systems and methods for charging a battery.

### BACKGROUND

Many modern electronic systems rely on one or more batteries for power. The batteries are typically recharged by connecting the system to a power source (e.g., an alternating current (AC) power outlet) via a power adapter and cable, for example. FIG. 1 illustrates battery charging in a typical electronic device. In this example, a power adapter 102, such as an AC-DC converter, is connected to a power source 101. The power adapter 102 may provide a direct current (DC) voltage and current to an electronic device 103 via a cable 120. Voltage and current from the power adapter 102 are received by a power interface, such as a power management integrated circuit (PMIC), which may convert the voltage and current from the power source 101 to different voltages and currents to drive various system components, such as one or more processors 111, communications electronics (e.g., radio frequency (RF) transceivers) 112, and one or more input/output devices 113, such as a touch screen display our audio system, for example. When disconnected from an external power source, the power interface 110 may receive voltage and current from the battery 114 to power the internal components, for example.

The power interface 110 may include a battery charging circuit 115 for charging the battery 114 when the battery 114 is discharged. One problem associated with battery chargers is power dissipation. The cable 120 may include resistance leading to thermal power dissipation as well as a reduction of the input voltage from the power adapter. Accordingly, the voltage at the input of the battery charger may be less than the voltage at the output of the power adapter due to current in the cable 120. To reduce these losses, some systems may use higher adapter voltages. However, higher adapter voltages can cause larger power dissipation in battery charger circuitry. For example, higher voltages across switching transistors in the battery charger may cause increases in power dissipation during charging. Additionally, higher input voltages can cause increased ripple in a battery charger's inductors, which can result in higher conduction losses and core losses, for example. Therefore, reducing power dissipation during the battery charging process is an ongoing challenge for battery operated systems.

### SUMMARY

According to one aspect of the present disclosure, a method for battery charging includes dynamically adjusting an input voltage of a battery charging circuit to maintain a duty cycle within a predetermined range. The method also includes charging a battery according to an output voltage of the battery charging circuit.

According to another aspect of the present disclosure, an apparatus for wireless communication includes means for dynamically adjusting an input voltage of a battery charging circuit to maintain a duty cycle within a predetermined range. The apparatus may also include means for charging a battery according to an output voltage of the battery charging circuit.

Another aspect discloses an apparatus for wireless communication and includes a memory and at least one processor coupled to the memory. The processor(s) is configured to dynamically adjust an input voltage of a battery charging circuit to maintain a duty cycle within a predetermined range. The processor(s) is also configured to charge a battery according to an output voltage of the battery charging circuit.

Yet another aspect discloses a computer program product for wireless communications in a wireless network. The computer-readable medium has non-transitory program code recorded thereon which, when executed by a processor(s), causes the processor(s) to dynamically adjust an input voltage of a battery charging circuit to maintain a duty cycle within a predetermined range. The computer-readable medium also has non-transitory program code recorded thereon which, when executed by the processor(s), causes the processor(s) to charge a battery according to an output voltage of the battery charging circuit.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 illustrates battery charging in a typical electronic device.

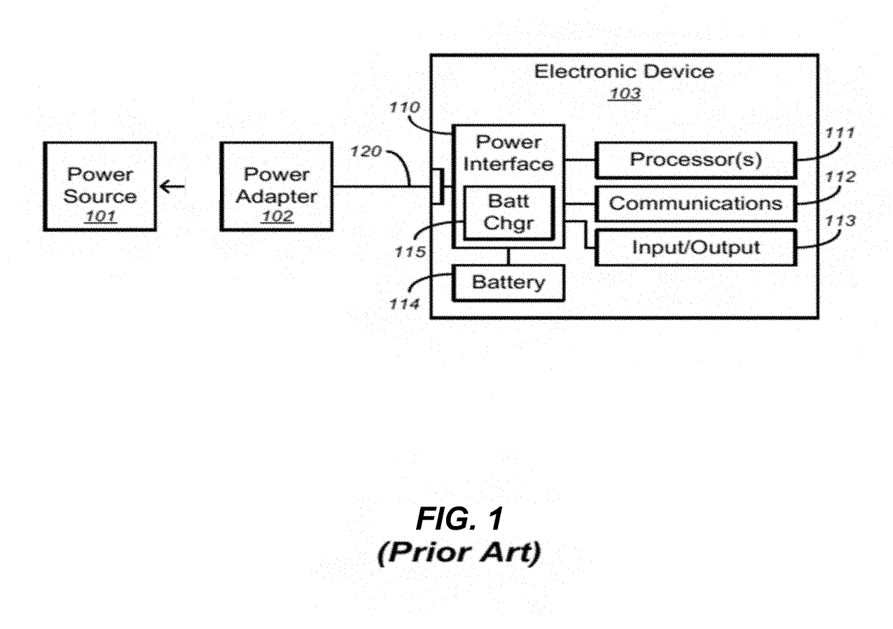

FIG. 2 illustrates an electronic device with a battery charging system according to aspects of the present disclosure.

FIG. 3 illustrates a method of charging a battery according to an aspect of the present disclosure.

FIG. 4 illustrates a method of charging a battery according to an aspect of the present disclosure.

FIG. 5 illustrates an electronic device with a battery charging system according to aspects of the present disclosure.

FIG. 6 illustrates a power management implementation according to aspects of the present disclosure.

FIG. 7 shows a duty cycle control process for minimizing or reducing power loss while maintaining performance according to aspects of the present disclosure.

FIG. 8 shows another duty cycle control process for minimizing or reducing power loss while maintaining performance according to aspects of the present disclosure.

FIG. 9 is a graph of power loss versus duty cycle including a transient response or transient voltage (Vpp) according to aspects of the present disclosure.

FIG. 10 shows yet another duty cycle control process for minimizing or reducing power loss while maintaining performance according to aspects of the present disclosure.

FIG. 11 shows a further duty cycle control process for minimizing or reducing power loss while maintaining performance according to aspects of the present disclosure.

FIG. 12 shows an additional duty cycle control process for minimizing or reducing power loss while maintaining performance according to aspects of the present disclosure.

FIG. 13 shows a duty cycle control process for charging a battery in accordance with the present disclosure.

FIG. 14 is a block diagram showing an exemplary wireless communication system in which a configuration of the disclosure may be advantageously employed.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Features and advantages of the present disclosure include battery charging systems and methods that may optimize power delivery from an external power source to a battery by modifying input voltage and battery charge current based on a variety of operational charging parameters including, but not limited to, temperature, duty cycle, and current limiting, for example.

User equipment (e.g., mobile devices) increasingly use higher capacity batteries as well as batteries that can accept higher charge rates. Consequently mobile original equipment manufacturers (e.g., original equipment manufacturers (OEMs)) are demanding faster charging (e.g., higher charge current levels and acceptable thermal limits). Thus, a need exists for reducing power loss while charging the batteries to improve the charging time.

Aspects of the disclosure are directed to improving the charging time (e.g., deliver a maximum or improved charge while minimizing or reducing power loss on the mobile device) by regulating a charging device duty cycle (e.g., buck duty cycle) of a switching regulator/converter (e.g., buck regulator) to a narrow range. For example, the charging time may be improved by dynamically adjusting an input voltage of a battery charging circuit to maintain a duty cycle within a predetermined range. In one aspect of the disclosure, the duty cycle may be detected at an output of a switching regulator. The battery charging circuit may adjust the input voltage by monitoring one or more input current limits, one or more transient voltages of a load, temperature and/or the duty cycle of the battery charging circuit. The battery charging circuit then adjusts the input voltage by generating control signals to increase the input voltage when (i) the input current limit is activated, (ii) the one or more transient voltages reach a threshold voltage and/or (iii) the duty cycle reaches a threshold duty cycle. In some aspects of the disclosure, generating control signals to increase the input voltage includes generating control signals to successively increase the input voltage across voltage values until a desired charge current is obtained.

A battery is charged according to an output voltage of the battery charging circuit based on the dynamically adjusted input voltage. In one aspect of the present disclosure, the duty cycle is dynamically regulated to maintain an input voltage Vin approximately equal to an output voltage Vout. This may include dynamically adjusting an adapter voltage to maintain the duty cycle within a predetermined range. For example, the duty cycle may be lowered when a state of a switching regulator (e.g., a battery field effect transistor (batFET)) is on.

A buck mode of operation is also improved/optimized depending on whether a batFET is on. The batFET can be used in three modes, current source, virtual diode and a switch. For example, the buck mode of operation may depend on the state of the batFET. In this case the batFET may be on or off when operating as a switch to change the buck mode of operation.

Reducing power loss while maintaining performance achieves improved or optimum configuration of the switching regulator for high efficiency. The improved configuration is maintained regardless of a switching topology. The switching topology may include a linear regulator, a buck converter/regulator, a boost converter/regulator, a buck-boost converter/regulator, etc.

For example, to maintain the improved configuration, the input voltage of the battery charger should be close to the output voltage of the battery charger. The output voltage for the battery charger is determined by a current voltage of the battery. The current voltage of the battery is based on a state of charge of the battery. If the battery is discharged, the current voltage of the battery is very low (e.g., 3.5 volts). When a charging cycle is initiated to charge the battery, the battery is charged, for example, to a higher voltage (e.g., 4.2 V-4.5 V), depending on the battery chemistry.

Thus, in a switching regulator (e.g., a switch mode buck regulator), the input voltage of the switching regulator should be maintained as close to the battery voltage as possible. In the buck regulator, when the input voltage and the output voltage are close, the duty cycle is substantially equal to 100%. A duty cycle of 100% indicates a threshold of highest efficiency. The buck regulator, however, is at risk of losing regulation of the battery charger when the duty cycle is 100%. At 100% duty cycle the buck will go out of regulation if any positive load step occurs, because the buck cannot increase the duty cycle to ramp up the inductor current as the duty cycle is already at 100%. Losing regulation of the battery charger causes a drop in the battery voltage, a loss of battery charge, and a longer charging time. Duty cycle is given by Vout/Vin. For example, the input voltage corresponds to the input voltage of the switching regulator and the output voltage corresponds to the output voltage of the switching regulator. If the input voltage drops to a level close to the output voltage, the duty cycle may increase. However, if the input voltage is too low, the duty cycle may reach a maximum duty cycle, and the system may not be able to produce the desired charge current.

Thus, aspects of the present disclosure are directed to improving charging time, while maintaining a reduced power loss of the user equipment battery. This feature may be achieved by regulating the duty cycle range close to 100%. To achieve this goal and to deliver as much charge to the battery as possible during charging without exceeding a specified temperature (e.g., skin temperature), an input voltage provided by a power device (e.g., of an adapter) can be adjusted to a desirable input voltage based on a request signal from a power management device. For example, the input voltage provided by the adapter may be adjusted incrementally in increments of 200 millivolts (my) up or down. The ability to adjust the input voltage allows for reducing power loss associated with charging the battery by requesting an improved input voltage. For example, a controller or control unit of the battery charger or the power management device (e.g., power management integrated circuit (PMIC)) dynamically provides a request signal to the power device based on a detected duty cycle of the switching regulator. The request signal is configured to cause the power device to adjust an input power (e.g., input voltage) provided to the battery charger, the switching regulator and/or the power management device is based on the detected duty cycle. For example, the duty cycle may be detected by duty cycle detection circuits.

Efficiency rises with higher duty cycles. By contrast, transient performance suffers if the duty cycle is too high because quickly responding to load steps becomes increasingly difficult. Thus, there is a range (e.g., an optimal range) of duty cycles for improved or optimal efficiency and acceptable transient response. In some aspects of the disclosure, the duty cycle range target is adjusted higher when the batFET is on because the battery stabilizes the system voltage if the buck response is slower.

In one aspect of the present disclosure, the input voltage generated by the power device is provided to the switching regulator of the power management device. The switching regulator includes a direct current input stage where an input voltage and an input current are sensed and a buck switching stage to provide switching and duty cycle regulation. In one aspect of the disclosure, a batFET may be included in the switching regulator to provide direct current output signals to the battery to control the charging of the battery. Alternatively, the batFET may be external to the switching regulator.

The mode of operation of the buck converter of the power management device is also improved/optimized depending on a state of the batFET. For example, the mode of operation of the buck converter is based on whether the batFET is on.

The input voltage (Vin) of the battery charger (e.g., buck converter) may be selected (as the adjusted voltage) in accordance with a first case when the batFET is not on. In this case, an input voltage is selected to improve efficiency without compromising performance (this mode is not limited to battery chargers). In some aspects of the disclosure, a batFET higher duty cycle can be achieved even in cases where the duty cycle is already at a 100%. The batFET being on increases the possibility of achieving a higher duty cycle to offset transient load step adjustments (e.g., increase in transient load step). The higher duty cycle can be achieved while maintaining a decent transient response because some of the load current comes from the buck and some from the battery. When the batFET is not fully on (e.g., when used as a current source or is off) then the load current (e.g., all of the load current) comes from the buck. In this case, the buck increases its duty cycle when a positive load step occurs (e.g., load jumps to three amperes from one ampere). Thus, a higher duty cycle range is selected when the batFET is on, and the buck's ability to increase its duty cycle is less important. In addition, the input voltage (Vin) of the buck converter may be selected (as the adjusted voltage) in accordance with a second case when the batFET is on. In this case, an input voltage is selected to improve efficiency while the battery is relied upon to attenuate system ripple and maintain system voltage during load steps.

The first case corresponds to a linear mode, such as when a linear regulator and the batFET actively control current to the battery. In the first case, the duty cycle of the buck converter is monitored and input voltages are requested by the controller or control device to maintain the duty cycle within a narrow range. The narrow range may be a predetermined narrow range. When the batFET is a current source, it cannot respond to load steps because it is not fully on. Thus, the narrow range is selected to achieve good buck transient response and good efficiency. Maintaining the duty cycle in the narrow range maintains a high efficiency while allowing a full charging current with no degradation in transient or output voltage ripple.

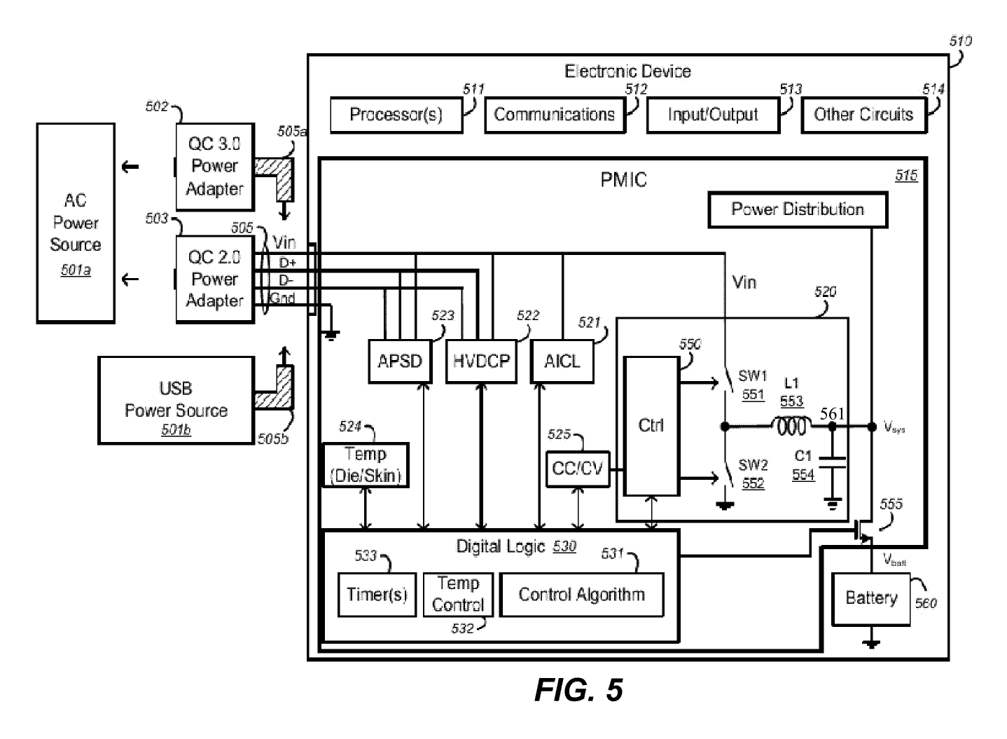

For example, in the first case, the duty cycle regulation is performed in a duty cycle range of 80% to 90% (e.g., Vout/Vin=0.8−0.9) to maintain performance. This duty cycle range may be lower relative to the duty cycle range of the second case. Of course other ranges are also possible. This duty cycle range specifies or automatically guarantees that the system can deliver a charging current to charge the battery, unless an input current limit is active. The higher duty cycle maintained by the present disclosure leads to improved efficiency of the battery charging operation. For example, power losses due to switching of the switching regulator are lower. Further, ripple (e.g., current ripple) at the output of an inductor coil (e.g., the inductor 553 described below with respect to FIG. 5) of the switching regulator is smaller when the duty cycle is maintained at a higher value (e.g., >80%). Losses associated with conduction and with the core of the switching regulator and/or the power management device are also reduced. As a result, the inductor of the switching regulator may be smaller, which results in chip area savings.

The aspects of the present disclosure further improve performance of the battery charging operation implemented with the switching regulator. For example, the duty cycle is maintained at a desirable level, thereby avoiding operating at a very high duty cycle that hurts performance and also avoiding unresponsiveness of the switching regulator during a positive load step. Further, without the battery charging operation being implemented with the switching regulator, the duty cycle (e.g., very high duty cycle levels) hurts the performance of a conventional battery charging operation. For example, a high duty cycle leads to refresh pulses that increase output voltage ripple of the switching regulator. In addition, a negative load step response is degraded if the switching regulator enters drop out at high loads and a control loop of the switching regulator opens. Further, operating at the undesirable duty cycle (e.g., very high duty cycle) the switching regulator renders a switching frequency variable. When an input current is limited (low power adapter), a higher input voltage enables the battery to charge faster at the expense of power loss in the battery charger.

The input voltage (Vin) of the buck converter is selected (as the adjusted voltage) in accordance with the second case when the batFET is “fully on.” When the batFET is “fully on,” the batFET acts as a resistor and does not actively control current to the battery. In the second case, for example, the duty cycle regulation is performed in a duty cycle range of 95% to 99% (e.g., Vout/Vin=0.95−0.99) to maintain performance. Of course other ranges are also possible. The duty cycle range in the second case is higher relative to the duty cycle range in the first case. To deliver a specified charge current, the control loop associated with the switching regulator operates so that a refresh loop is not active.

A refresh is triggered when either an output voltage is too low (e.g., below regulation) or charging currents are not being delivered. Therefore avoiding a refresh is desirable. While the ideal regulator regulates at a 100% duty cycle, not all regulators can regulate at 100% duty cycle. If a high side switch (e.g., high side FET) is n-type, for example, a bootstrap capacitor may be included to keep the gate on while the high side FET is on. The current drawn on this capacitor, however, reduces the gate to source voltage (V_{GS}) of the high side FET with time. Eventually, a refresh occurs where the low side FET turns on to recharge the boot capacitor, which limits the duty cycle (e.g., to about 99%). Aspects, of the present disclosure reduce the occurrence of a refresh. For example, the input voltage (Vin) may be increased to avoid a refresh triggered by a low input voltage.

To reduce core loss and switching frequency (thereby improving efficiency) the input voltage (Vin) is adjusted in accordance with aspects of the present disclosure so that a buck pulse skips and the frequency falls. An improved efficiency (e.g., highest possible efficiency) in the second case (batFET on) occurs when the duty cycle is high enough for the high side FET to stay on for more than one clock cycle but not long enough to trigger a refresh. An exemplary refresh pulse may occur every 20 μs for a switching frequency of 1 MHz. The high side FET stays on for 20 clock cycles before a refresh occurs. Rather than switching at 1 MHz, the input voltage (Vin) is adjusted down so that the high side FET is on for four consecutive cycles (e.g., 80 clock cycles) followed by a quick off time of 100 ns so that the effective frequency is 1/4 82 s or 250 KHz. Accordingly, the switching losses are reduced and the effective duty cycle is given by 4.9 μs/5 μs or 98%. In the second case, it is desirable to adjust the input voltage (Vin) so that the frequency falls as the batFET is fully on to provide supplemental load current if there is a load step. Thus, in the mode of operation corresponding to the second case, positive load steps on the system are supported by additional current from the battery. The battery can also sink current during negative load steps.

The battery may be monitored to determine whether the battery is charging or discharging. For example, the controller may request a higher input voltage when the battery is discharging. Similarly, as in the first case, a higher input voltage is requested if an input current limit is active. In a buck regulator, the input voltage is slightly higher than the output voltage. The power loss associated with the second case is less than the power loss associated with the first case because switching losses fall with frequency.

Aspects of the present disclosure may be implemented in a single power management component or device configured to enable adjustment functionality of the input voltage without additional integrated circuit (ICs) and/or external components. In some aspects the adjustment of the input voltage is enabled by partitioning existing circuitry on an integrated circuit (instead of developing additional circuitry).

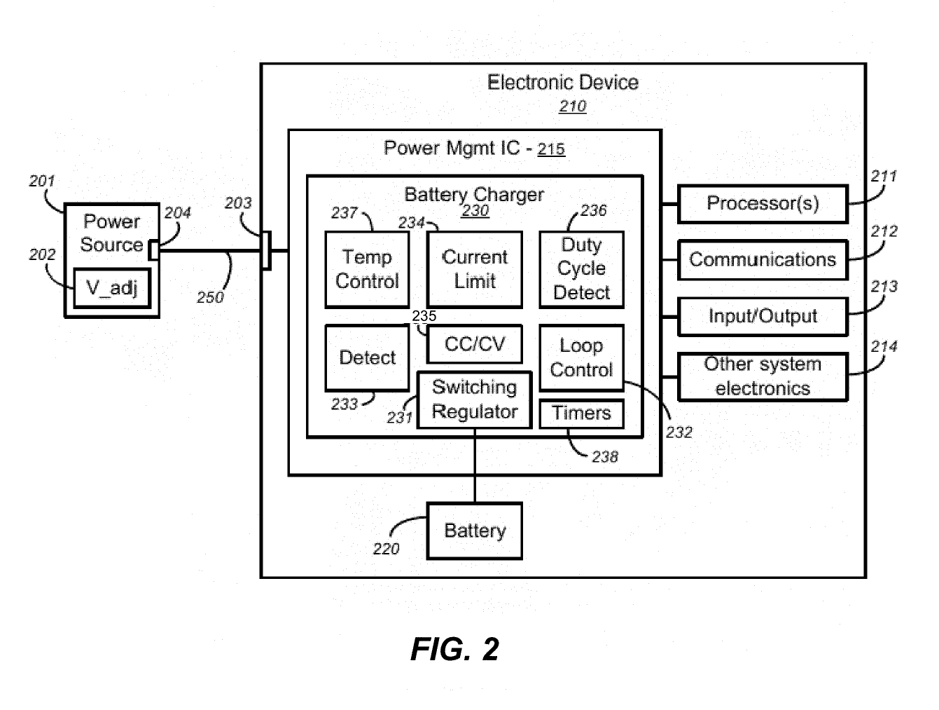

FIG. 2 illustrates an electronic device with a battery charging system. The electronic device 210 may include a rechargeable battery 220. The battery 220 may provide power to various internal circuits such as one or more processors 211, communications circuits 212 (e.g., RF communications such as WiFi, cellular, Bluetooth, and global positioning systems (GPS)), input/output circuits 213 such as displays (e.g., touch screens), audio inputs and outputs and haptics, and various other system electronics 214, for example. Examples of the electronic device 210 may include a cellular phone (e.g., a smart phone), tablet computer, or other battery operated electronic devices as small as a watch or biometric sensor (e.g., a fitness electronic device) to larger devices (systems) operating off one or more rechargeable batteries.

In some situations, the electronic device 210 may receive power from an external power source 201. For example, the external power source 201 may be coupled to the electronic device 210 over one or more electrically conductive wires 250 (e.g., cable), which may plug into connectors 203 and 204, for example. External power sources according to certain aspects may be configured to produce different voltage values in response to control signals using voltage adjust circuitry 202 (V_adj). Example external power sources include AC wall adapters (wall chargers) or Universal Serial Bus (USB) ports, which may produce different voltages at the input of the electronic device in response to control signals received over one or more wires 250. For example, one technique for causing an AC wall adapter to produce different voltages is known as Quick Charge 2.0™ from Qualcomm®, which may configure an AC wall adapter to produce output voltages of 5 volts, 9 volts, and 12 volts, for example, in response to control signals communicated over a cable between the electronic device and the wall adapter. Another technique for causing an AC wall adapter to produce different voltages is known as Quick Charge 3.0™ from Qualcomm®, which may configure an AC wall adapter to produce multiple different output voltages that can change in as little as 200 mV steps, for example, in response to control signals communicated over a cable between the electronic device and the wall adapter. Some USB ports may also support producing different voltages in response to control signals received from an electronic device, including USB ports supporting USB power delivery over USB type-C cables. The above example external power sources are only example applications of the techniques described, which may have applications beyond such systems.

When the external power source 201 is coupled to the electronic device 210, an input voltage (Vin) is received by a battery charger 230. Initially, the input voltage Vin may have a first voltage value (e.g., 5 v). Aspects of the present disclosure include configuring the battery charger 230 to produce a particular charge current (e.g., a desired charge current) into the battery 220. However, some external power sources may not be able to exceed a particular maximum output current from the power source to the electronic device. Thus, if the initial input voltage value and charge current value, for example, exceed the capabilities of the external power source, the desired charge current may not be obtained. Additionally, current from the external power source may cause a voltage drop across the cable, which may reduce the input voltage value. If the input voltage value is too low to support proper charging, the charging operation may not operate properly. Furthermore, if the desired charge current and voltage are obtained, the electronic device may heat up beyond allowable thermal tolerances. Accordingly, in one aspect, temperature inside the electronic device as well as an input current limit in the battery charging circuit and/or duty cycle may be monitored and used to control the voltage and current received from the external power source to optimize battery charging, for example.

As illustrated in FIG. 2, a battery charger 230 may be part of a power management integrated circuit 215 (PMIC), for example. In some aspects, battery charging circuits may alternatively be stand-alone systems. In this example, the battery charger 230 includes a switching regulator 231 and loop control circuits 232. The switching regulator 231 may be a buck regulator, for example, where Vin is greater than Vout. Loop control circuits 232 may control the switching regulator to produce an output voltage or current to the battery, for example. The battery charger 230 further includes detection circuits 233, current limit circuits 234, controlled current mode charging and controlled voltage mode charging circuits (CC/CV) 235, duty cycle detection circuits 236, temperature control circuits 237, and timers 238, for example.

Detection circuits may be used to detect voltages and/or currents (e.g., input voltage and/or input current). Example detection circuits that may be used in certain aspects are described in more detail below. Current limit circuits 234 may sense current (e.g., input current) and implement input current limiting. For example, when the value of the input current exceeds a particular current limit (e.g., which may be programmable), the current limit circuit may activate and control the switching regulator to maintain the input current at a particular input current limit value.

Current control charging and voltage control charging circuits (CC/CV) 235 may be used to configure the switching regulator to perform controlled current charging (e.g., constant current) or controlled voltage charging (e.g., constant voltage). In some aspects, loop control circuitry may include a pulse width modulator having an input coupled to multiple control loops, including an input current limit control loop, current control loop, and voltage control loop (e.g., arranged as a wired OR), so that the battery charger may be configured to charge the battery using different control parameters, for example. Duty cycle detection circuits 236 may monitor the duty cycle. As described in more detail below, when the duty cycle is at a maximum duty cycle, duty cycle detection circuits may be used to reconfigure the charging parameters to optimize charging.

Temperature control circuits 237 may include temperature monitors and control circuitry. As described below, temperature detectors may be on the same integrated circuit die or external to the die to measure skin temperature, for example. Temperature control circuits 237 may include digital circuits that receive an indication that a temperature has exceeded one or more threshold temperatures. As described below, the system may be reconfigured based on temperature to optimize charging. Timers 238 may be used to control the timing of various charging operations.

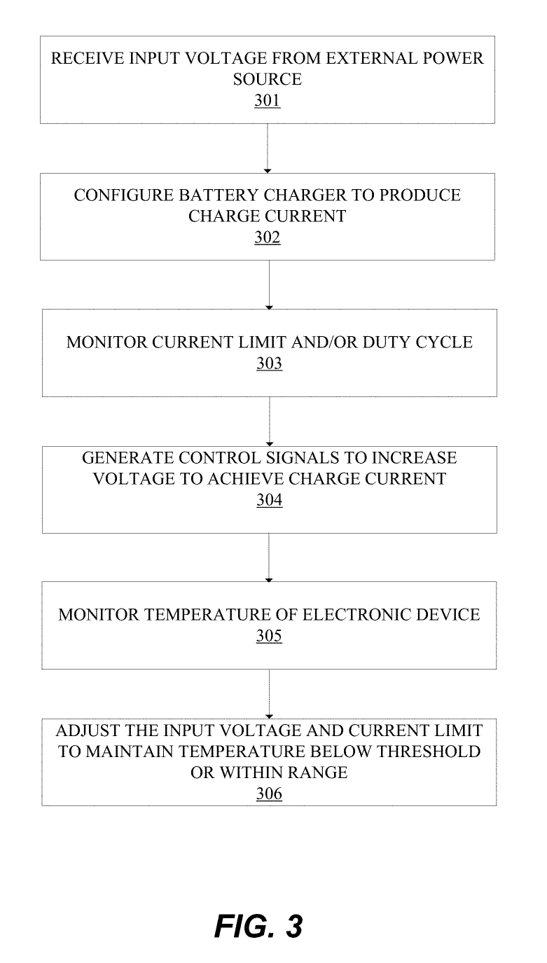

FIG. 3 illustrates a method of charging a battery according to aspects of the present disclosure. In one aspect, an input voltage is received in a battery charging circuit on an electronic device from an external power source as shown at block 301. The input voltage may have a particular initial voltage value (e.g., 5 v). At block 302, the battery charging circuit is configured to produce a charge current (Ichg) having a particular current value (e.g., 3 amps) into the battery. In some instances, the configured charge current may be a desired charge current, and such current may exceed the capabilities of the external power source. For example, an external power source may not be able to produce 3 amps@5 volts. Alternatively, resistance in the cable at high currents may cause a voltage drop between the output of the external power source (e.g., at the connector 204) and the input of the battery charger (e.g., at the connector 203). Accordingly, battery charging in this configuration may not be able to occur. Aspects of the present disclosure may monitor internal system parameters, such as input current limit and/or duty cycle, to detect conditions where battery charging is suboptimal.

For example, in one aspect, the battery charging circuit monitors the input current limit, duty cycle, or both at block 303. For instance, certain aspects may determine a maximum current capability of the external power source to set the input current limit. If the maximum input current is reached, the input current limit circuit is activated (e.g., the switching regulator may be controlled to maintain the input current below a preset maximum input current limit value). In this case, it may be desirable to increase the input voltage from the external power sources to increase the input power to the battery charger, for example, to achieve the desired charge current. Alternatively, if the input voltage drops to a level close to the output voltage (e.g., due to resistive drops in the cable), the duty cycle may increase. If the input voltage is too low, the duty cycle may reach a maximum duty cycle, and the system may not be able to produce the desired charge current. Accordingly, it may be desirable to increase the input voltage from the external power sources to increase Vin and increase the charge current to desired levels, for example.

Therefore, at block 304, the battery charger may generate control signals (e.g., to the external power source) to increase the first voltage value of the input voltage to at least one second voltage value if either (i) the input current limit is activated or (ii) the duty cycle reaches a maximum duty cycle, for example. In one aspect, the battery charger may generate control signals to successively increase the input voltage across voltage values until a desired charge current is obtained. For example, in the case of Quick Charge 2.0™, the battery charger may successively increase Vin from 5 v to 9 v, and then to 12 v to produce the desired charge current. In the case of Quick Charge 3.0™, the battery charger may successively increase Vin above 5 v in 200 mV steps until either the current limit and/or the duty cycle indicate that the desired charge current is being produced, for example.

At block 305, the battery charger may monitor temperature at various locations of the electronic device. As illustrated in the example below, temperature may be sensed at one location or multiple different physical locations. For instance, a temperature sensor may be placed external to the PMIC to sense a skin temperature of the electronic device. An external temperature sensor positioned to sense skin temperature may generate a signal indicating that the skin temperature has exceeded one or more predefined threshold temperatures, each of which may be programmable. Similarly, a temperature sensor may be implemented on the same substrate as the PMIC to sense a die temperature of the PMIC (or on the die of another device). A temperature sensor positioned to sense die temperature may similarly generate a signal indicating that the die temperature has exceeded a predefined threshold temperature, which may also be programmable, for example. In one aspect, sensing the temperature inside the electronic device comprises a logical OR of a skin temperature signal and a die temperature signal so that the system is regulated within safe operating ranges for both external temperature requirements and limits of the integrated circuits. Aspects of the present disclosure may adjust the input voltage and current limit to maintain temperature below a threshold temperature or within a particular temperature range at block 306.

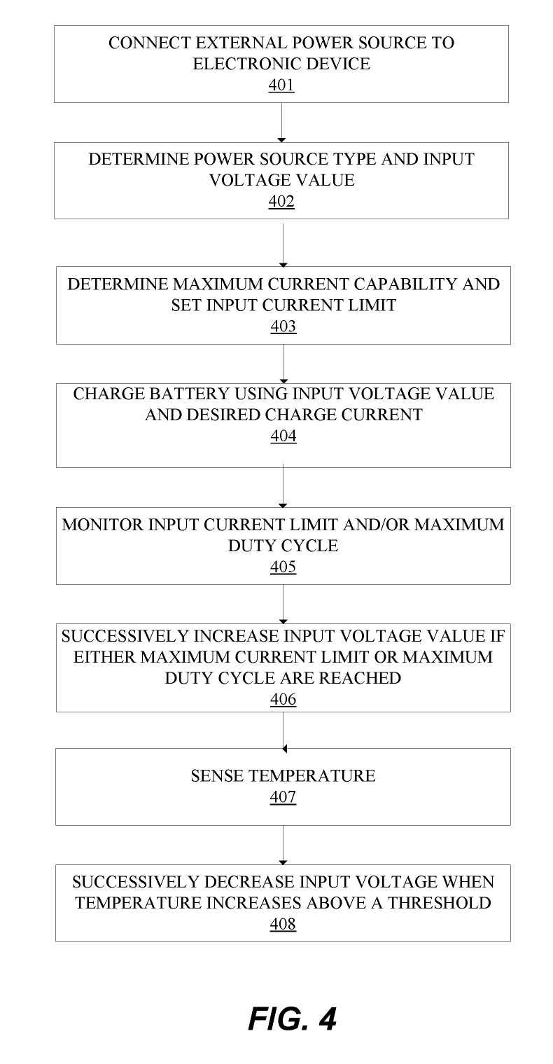

FIG. 4 illustrates a method of charging a battery according to another aspect of the disclosure. At block 401 an external power source with a configurable output voltage is connected to an electronic device. At block 402, a battery charging circuit in the electronic device determines the type of power source and the input voltage value. An example of automatic power source detection (APSD) is illustrated below. At block 403, the battery charging circuit determines a maximum current capability of the external power source and sets an input current limit. An example of an automatic input current limit (AICL) circuit is illustrated below.

At block 404, battery charging begins and the battery is charged using the input voltage value. The battery charger may be configured to produce a particular desired battery charge current. At block 405, the input current limit and/or duty cycle may be monitored. If the battery charger input current limit is activated or if a maximum duty cycle is reached, then the battery charger may generate control signals to successively increase the input voltage across a range of voltage values until the desired charge current is obtained at block 406. At block 407, the temperature is sensed (e.g., skin and/or die temperature). At block 408, if the temperature increases above a threshold temperature, then the battery charger may cause the external power source to decrease the input voltage value. In some aspects, the battery charger may generate control signals to successively decrease the input voltage across a range of voltage values until the temperature decreases below the threshold temperature.

Different external power sources may have different voltage adjustment capabilities. For example, different voltage values for some external power sources may differ by more than 1 volt (e.g., 5 v, 9 v, and 12 v). Alternatively, other power sources may have very fine voltage resolutions so that different voltage values differ by less than one volt (e.g., 200 mV steps). Accordingly, different aspects of the present disclosure may detect an external power source type and implement input voltage and input current limit adjustments in different sequences. In one aspect, a battery charger may decrease the input current limit across a range of input current limit values to decrease the temperature below the threshold temperature after generating control signals to decrease the input voltage from the external power source. For power sources with the ability to adjust the input voltage in small steps (e.g., less than 1 volt), it may be advantageous to adjust the input voltage before adjusting the current limit settings. Alternatively, for power sources that have limited voltage adjustment capability (e.g., greater than 1 volt), it may be advantageous to adjust the input current limit settings before adjusting the input voltage. Accordingly, in another aspect, the battery charger may decrease the input current limit across a range of input current limit values to decrease the temperature below the threshold temperature before generating control signals to decrease the input voltage from the external power source.

FIG. 5 illustrates an example implementation of an electronic device with a battery charging system. In this example, an electronic device 510 may be coupled to a variety of external power sources 501a and 501b using a USB cable 505. The USB cable 505 may include a power supply voltage line Vin, a ground (or return) line Gnd, and data lines D+ and D− for carrying data. Some aspects may further include other lines, such as for communicating dedicated configuration information, for example. In this example, electronic device 510 may be coupled to an AC power source 501a using a Quick Charge 3.0™ power adapter 502 (or equivalent) using a cable 505a or a Quick Charge 2.0™ power adapter 503 (or equivalent) using the cable 505. AC power adapters convert AC power from the AC power source into DC voltage and current. Additionally, the electronic device 510 may be coupled to a USB power source 501b having a configurable DC voltage using a cable 505b.

The electronic device 510 may include a PMIC 515 to provide regulated power supply voltages to one or more processors 511, communications circuits 512, I/O circuits 513, and other circuits as mentioned above. In this example, battery charging circuits are included on a PMIC 515, although in other aspects, battery charging circuits may be on another integrated circuit die, for example. In this example, battery charging circuits include a buck switching regulator 520 (i.e., Vsys is less than Vin), an automatic input current limit (AICL) circuit 521, a high voltage dedicated charge port (HVDCP) circuit 522, automatic power source detection (APSD) circuit 523, temperature detection circuits 524, and controlled current/controlled voltage (CC/CV) circuit 525.

A switching regulator 520 includes a high side switch 551 and low side switch 552, which may both be MOS transistors, an inductor 553, an output capacitor 554, and control circuitry 550, which may include pulse width modulation circuits and gate driver circuits to turn switches 551 and 552 ON and OFF, for example. An output of the switching regulator produces a system voltage Vsys, which may be coupled to a battery 560 through a switch transistor 555 during battery charging and coupled to a power distribution circuit to produce regulated voltages for other system circuit blocks. The battery 560 produces voltage Vbatt, which may be coupled through a transistor 555 to provide the system voltage when an external source is not connected, for example.

The AICL circuit 521 may determine a maximum current capability of an external power source. One example circuit for performing automatic input current limiting (AICL) is disclosed in U.S. Pat. No. 7,990,106 in the name of Abid et al., issued Aug. 2, 2011, the disclosure of which is expressly incorporated herein by reference in its entirety.

The APSD circuit 523 may determine a type of external power source, for example. One example circuit for performing automatic power source detection (APSD) is disclosed in U.S. Patent Publication No. 2012/0217935 to Hawawini et al., filed on Oct. 4, 2011, the disclosure of which is expressly incorporated herein by reference in its entirety.

The HVDCP circuit 522 may control an external power source to produce different voltages. One example circuit for controlling a high voltage dedicated charge port (HVDCP) is disclosed in U.S. Patent Publication No. 2014/0122909 to Hawawini et al., filed on Aug. 1, 2013, the disclosure of which is expressly incorporated herein by reference in its entirety.

The controlled current/controlled voltage (CC/CV) circuit 525 may configure the switching regulator to operate in one or more current control modes (e.g., constant precharge current or fast charge current) and a voltage control mode (e.g., constant “float” voltage charging). One example circuit for performing controlled voltage and controlled current charging is disclosed in U.S. Pat. No. 7,880,445 to Hussain et al, issued on Feb. 1, 2011, the disclosure of which is expressly incorporated herein by reference in its entirety.

Temperature detection circuits 524 may include analog to digital converters (ADC) or comparators to receive digital or analog temperature sensor signals, respectively, and either translate the digital temperature sensor signals into temperature data or compare the analog temperature sensor signals against reference values to determine if a temperature is above or below one or more thresholds, for example.

In this example, improved charging may be implemented using digital logic 530 in communication with the above mentioned components. Here, a control algorithm 531 for charging the battery is implemented as part of the digital logic 530. However, it is to be understood that other aspects may implement the methods described using an algorithm operating on a processor in communication with circuit components and configured with software to perform the described techniques. Digital logic 530 may further include timers 533 and temperature control 532. Digital logic 530 may receive temperature information from temperature detection circuits 524. Digital logic 530 may include logic for supporting the APSD circuits, AICL circuits, and HVDCP circuits, for example.

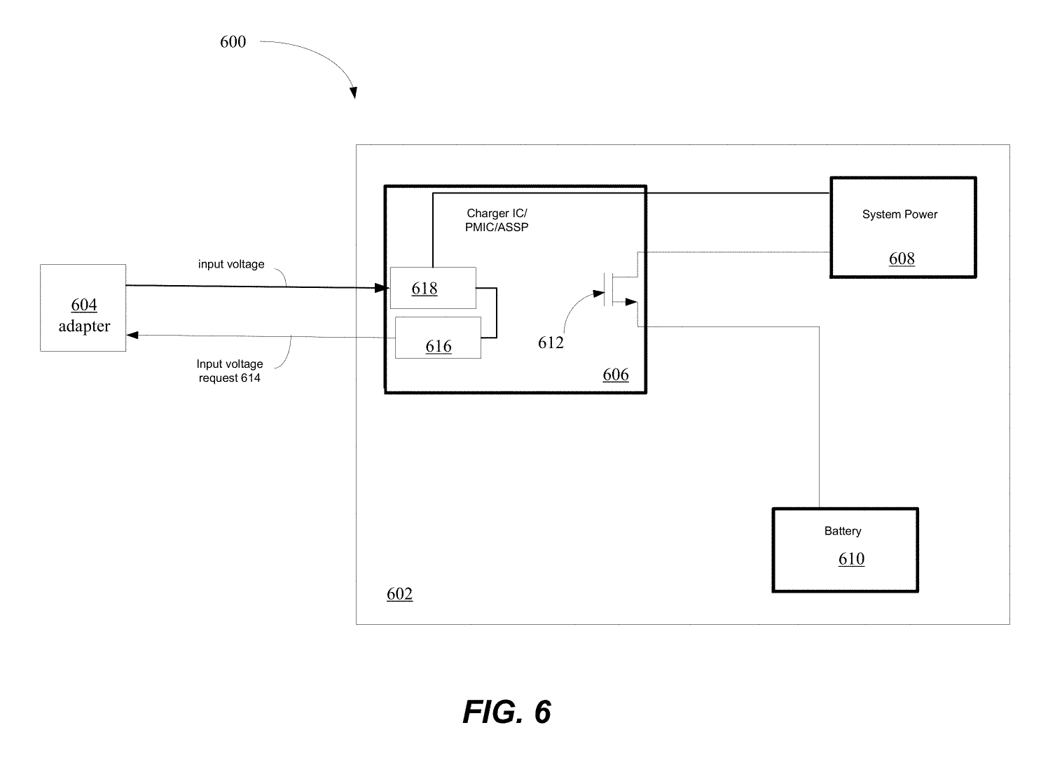

FIG. 6 illustrates a power management implementation 600 according to aspects of the present disclosure. In one aspect of the disclosure, the power management implementation 600 may be achieved by a power management system 602. The power management system 602 includes a power management component or device 606, a system power device 608 (e.g., a chipset), and a battery 610. The power management device 606 may be a power management integrated circuit, a charger integrated circuit, an application specific standard product, etc. In one aspect of the disclosure, the power management device 606 includes a battery field effect transistor (batFET) 612 (e.g., transistor 555 of FIG. 5) that provides direct current output signals to the battery 610 to control the charging of the battery 610.

The power management device 606 may include a charging integrated circuit 618 to charge the battery 610. The charging integrated circuit 618 includes circuitry to provide battery charging functionality that may be provided using a battery charger (e.g., the battery charger 230 of FIG. 2). For example, the charging integrated circuit 618 includes a switching regulator, such as a buck converter, a boost converter or buck-or-boost converter. The switching regulator may be similar to the switching regulator 520 of FIG. 5. The system power device 608 is configured to produce different voltage values in response to control signals, such as a request signal 614 from a control device or controller 616 of the power management device 606, using the voltage adjust circuitry 202 (V_adj), for example. The controller may include digital logic or control circuitry (as described with respect to FIG. 5). Alternatively, all or portions of the controller 616 may be external but coupled to the power management device 606. For example, the controller 616 may include a processor (e.g., processor 111 or 211).

In one aspect of the disclosure, the duty cycle detection circuits 236 may monitor the duty cycle. In some implementations, the duty cycle may be detected at an output of the switching regulator. The results of monitoring the duty cycle may be processed by the power management device 606. For example, the controller 616 may process the results of monitoring the duty cycle to determine the desirable adjustment to the input voltage provided to the power management device 606 by the adapter 604. The controller 616 may then send the request signal 614 (e.g., input voltage request signal) to the adapter 604 to cause the adapter 604 to provide the desirable adjusted input voltage to the power management device 606.

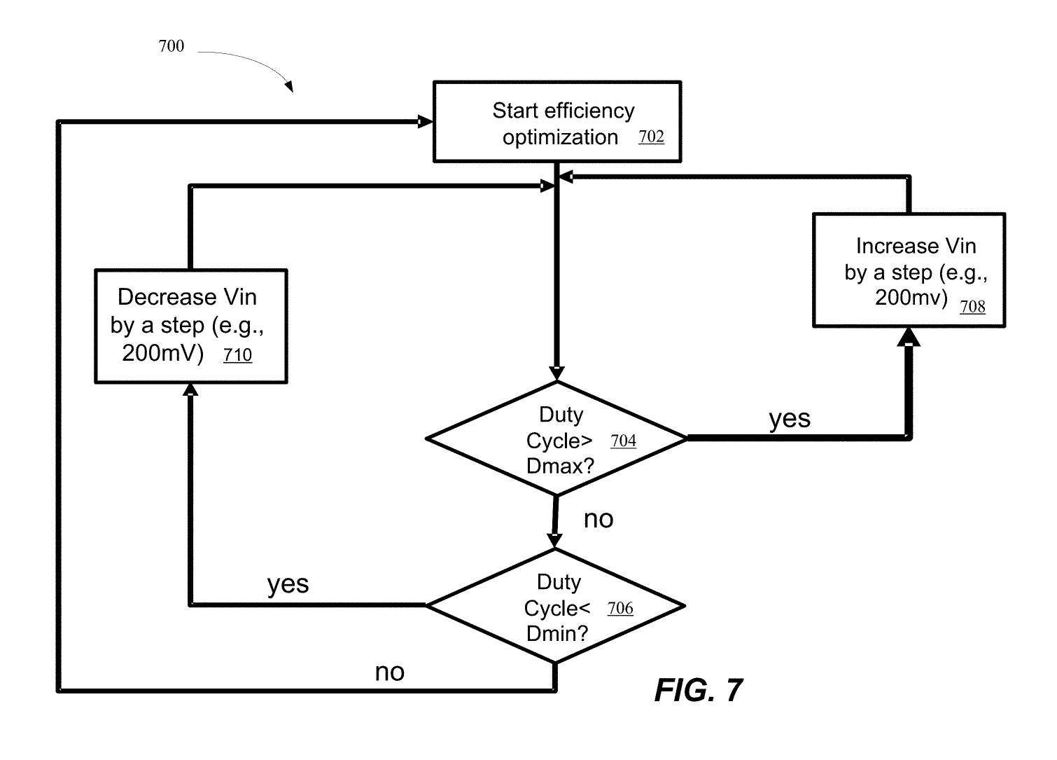

FIG. 7 shows a duty cycle control process 700 for minimizing or reducing power loss while maintaining performance according to aspects of the present disclosure. According to the illustration in FIG. 7, a circuit (e.g., duty cycle detection circuits 236) monitors the duty cycle of the buck converter. For example, an efficiency optimization process starts at block 702 where the duty cycle of the buck converter is monitored for efficiency optimization. The process then continues to block 704 where it is determined whether the duty cycle is greater than a first threshold duty cycle (e.g., maximum duty cycle (Dmax)). If the duty cycle is greater than the first threshold duty cycle, a higher input voltage is requested. The higher input voltage may be requested by the controller 616. For example, the controller 616 may be notified or identify that the duty cycle is greater than the first threshold duty cycle. In response, the controller generates a request signal (e.g., an input voltage request signal 614) to the power device (e.g., adapter 604) to cause the power device to adjust the input voltage provided to the buck converter to a higher input voltage.

The input voltage provided to the buck converter by the power device is then increased by a step, as shown in block 708. For example, the input voltage (Vin) is increased by 200 millivolts (mV), although other voltage steps ae possible. Thus, the resulting or adjusted input voltage may be the sum of a previous input voltage plus 200 mV. The process then continues back to block 704 where the implementation is repeated to achieve the desirable input voltage.

If, however, the duty cycle is not greater than the first threshold duty cycle, the process continues to block 706 where it is determined whether the duty cycle is less than a second threshold duty cycle (e.g., minimum duty cycle (Dmin)). If the duty cycle is less than the second threshold duty cycle, a lower input voltage is requested. The lower input voltage may be requested by the controller 616. For example, the controller 616 may be notified or identifies that the duty cycle is less than the second threshold duty cycle. In response, the controller generates a request signal (e.g., an input voltage request signal 614) to the power device (e.g., adapter 604) to cause the power device to adjust the input voltage provided to the buck converter to a lower input voltage.

The input voltage provided to the buck converter by the power device is then decreased by a step, as shown in block 710. For example, the input voltage (Vin) is decreased by 200 millivolts (mV), although other voltage steps are possible. Thus, the resulting or adjusted input voltage may be the difference of a previous input voltage minus 200 mV. The process then continues back to block 704 where the implementation is repeated to achieve the desirable input voltage. If, however, the duty cycle is not less than the second threshold duty cycle, the process continues to the starting block 702.

Thus, the input voltage is regulated to control the duty cycle with a narrow range for optimal efficiency and performance. The range is adjusted higher when the batFET is on to reduce power loss. For example, in the first case when the batFET is “not fully on,” the duty cycle regulation is performed in a duty cycle range of 80% to 90% (e.g., Vout/Vin=0.8−0.9) to maintain performance. In the second case when the batFET is “fully on,” the duty cycle regulation is performed in a duty cycle range of, for example, 95% to 99% (e.g., Vout/Vin=0.95−0.99) to maintain performance. Thus, the duty cycle range is adjusted higher when the batFET is “fully on” relative to the adjustment of the duty cycle range when the batFET is “not fully on”. A desirable range of voltages for the first case and the second case may be predefined based on an efficiency/performance tradeoff.

In one aspect, the duty cycle range may be adjusted by the control device or controller 616. The control device or controller 616 may set the duty cycle for the control loop/buck (e.g., charging integrated circuit 618) by requesting an input voltage from the adapter 604, for example. The control device or controller 616 is configured to determine the input voltage to be requested to achieve a desirable duty cycle.

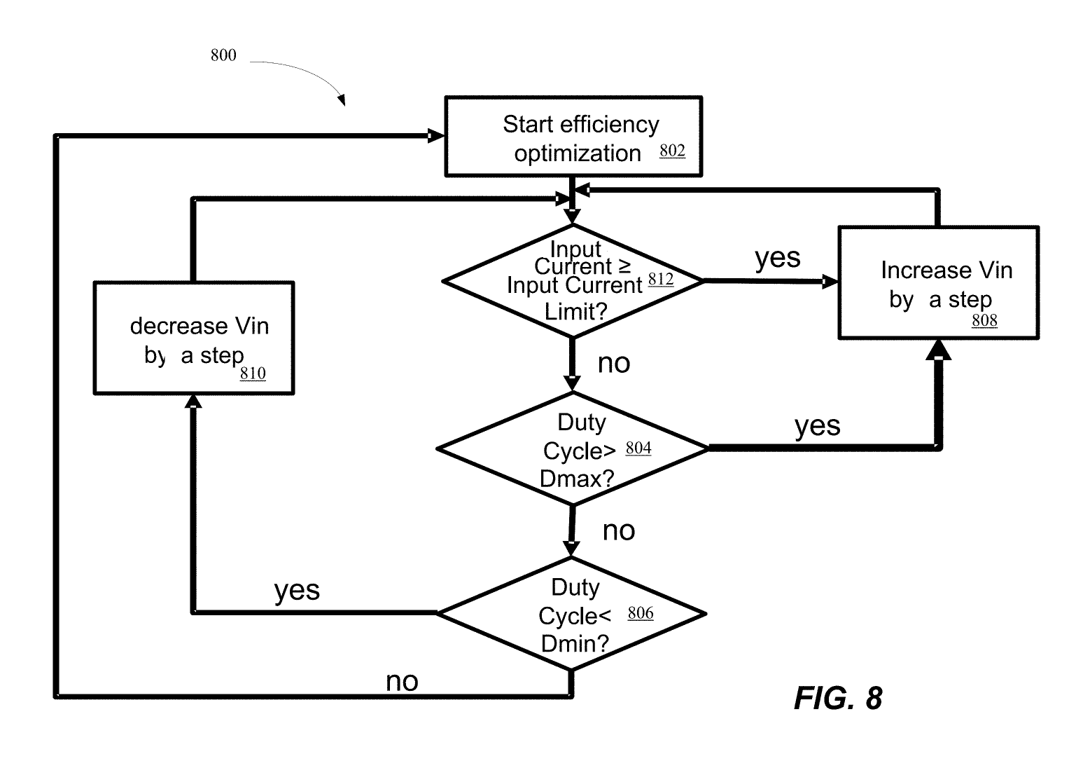

FIG. 8 shows another duty cycle control process 800 for minimizing or reducing power loss while maintaining performance according to aspects of the present disclosure. The duty cycle control process of FIG. 8 is similar to the duty control process of FIG. 7. The difference is that FIG. 8 introduces a new condition (e.g., input current limit) in addition to the conditions introduced in FIG. 7. For example, in FIG. 8, the process starts at block 802 where the duty cycle and the input current to the switching regulator (e.g., switching regulator 520) are monitored for efficiency optimization. The input current may be monitored by an automatic input current limit circuit (e.g., automatic input current limit circuit 521). The process then continues to block 812 where it is determined whether the input current to the switching regulator is greater than or equal to an input current limit. If the input current is greater than or equal to the input current limit, a higher input voltage is requested. In this case, when the input current is too high then the input voltage is increased. An increased or higher input voltage may be requested by the controller 616. For example, the input voltage provided to the buck converter by the power device is increased by a step, as shown in block 808.

However, if the input current is less than the input current limit, the process continues to block 804 where it is determined whether the duty cycle is greater than the first threshold duty cycle (e.g., maximum duty cycle (Dmax)). The processes at blocks 804, 808, 806 and 810 are similar to the processes in blocks 704, 708, 706 and 710 of FIG. 7.

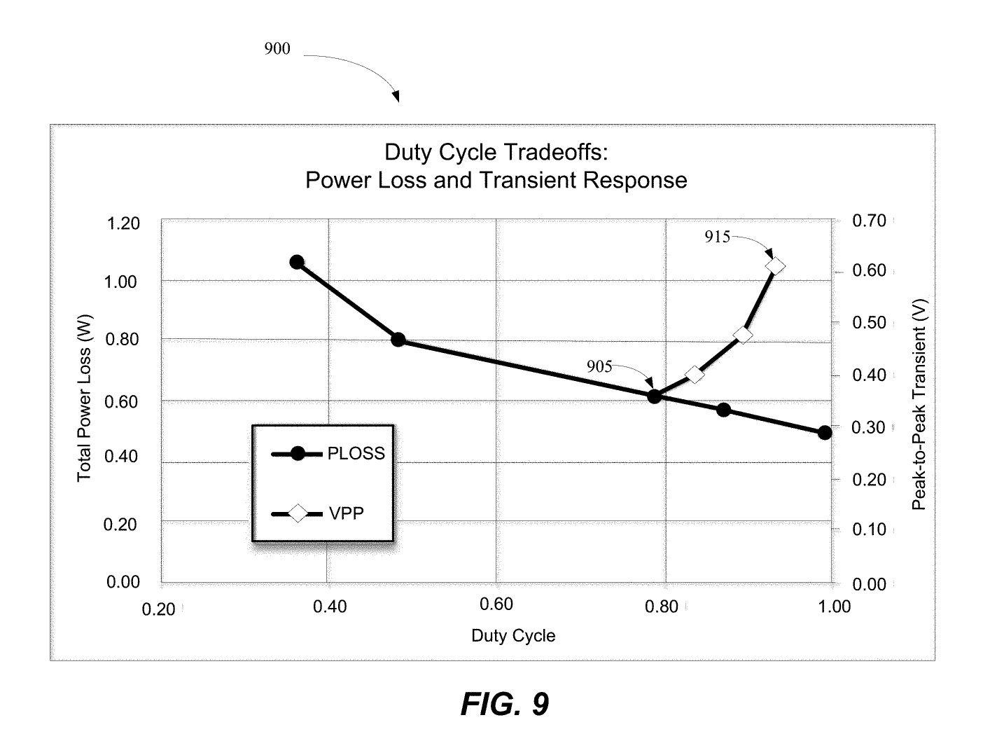

FIG. 9 is a graph 900 of power loss versus duty cycle including a transient response or transient voltage (Vpp) according to aspects of the present disclosure. For example, the power losses may be due to switching of the switching regulator. The y-axis represents total power loss and the x-axis represents duty cycle. For example, in an alternative implementation, after checking the input current against the input current limit, it can also be checked whether a transient voltage is too high. For example, the transient voltage may be compared against a transient voltage threshold as the input current is compared against an input current limit in block 812 of FIG. 8. If the transient voltage is greater than the transient voltage threshold, then Vin is increased. Otherwise, the process proceeds to block 804 where the duty cycle is compared with Dmax and so forth. The charging current is not monitored because the buck can deliver the charging current if it is not in drop out.

Transient voltage is not detected. Instead, design and simulations can indicate what load steps the buck can respond to given its duty cycle. For example, when the duty cycle is low (e.g., 85%) and the batFET is not fully on, positive load steps may be quickly responded to by demanding a higher duty cycle. When the duty cycle is high (e.g., 97%) and the batFET is on, the transient response is sufficient, even with the limited room to increase duty cycle, because the battery provides extra system power (e.g., current).

As the duty cycle increases, the transient voltage, Vpp, dramatically increases after a threshold duty cycle (e.g., from points 905 to 915). The input voltage of the switching regulator may be adjusted based on the transient performance. For example, control signals may be generated to increase the input voltage when the transient voltage reaches a threshold voltage or when the duty cycle reaches a threshold duty cycle.

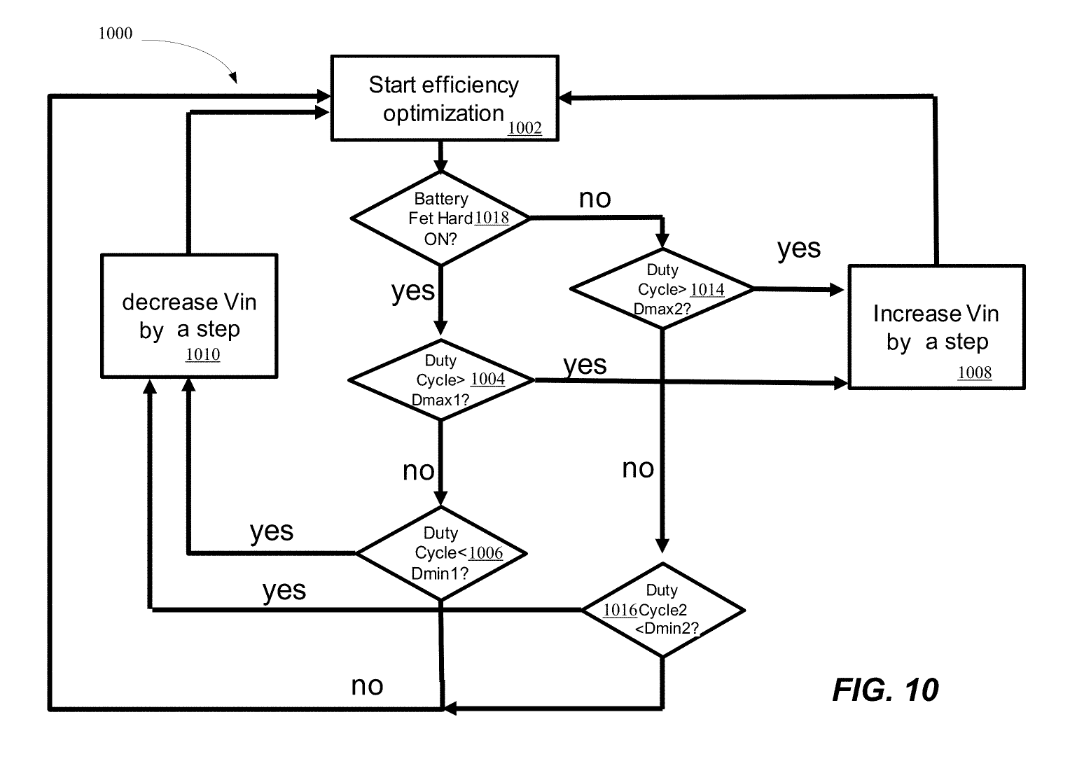

FIG. 10 shows yet another duty cycle control process 1000 for minimizing or reducing power loss while maintaining performance according to aspects of the present disclosure. The duty cycle control process 1000 FIG. 10 is similar to the duty cycle control process 700 of FIG. 7. The difference is that FIG. 10 introduces a new condition (e.g., whether the batFET is on) and corresponding path, in addition to the conditions introduced in FIG. 7.

According to the illustration in FIG. 10, a circuit monitors the duty cycle of the buck converter to determine whether to adjust the input voltage based on whether the batFET is on. For example, in FIG. 10, the process starts at block 1002 where the duty cycle and the batFET (e.g., switch transistor 555) are monitored for efficiency optimization. The batFET may be monitored by a control device or detection circuits (e.g., detection circuits 233, control circuitry 550 or digital logic 530) to determine whether the batFET is on. The process then continues to block 1018 where it is determined whether the batFET is on.

A first path including blocks 1004, 1006, 1008, 1010 and 1002 is followed when it is determined that the batFET is on. The implementation in blocks 1004, 1006, 1008, and 1010 of the first path is similar to the implementation of the blocks 704, 706, 708, and 710 of FIG. 7. For example, when the batFET is on and the duty cycle is greater than a third threshold duty cycle (e.g., maximum duty cycle (Dmax1)) as determined in block 1004, a higher input voltage is requested. For example, the input voltage Vin is increased by 200 my, as shown in block 1008. If the duty cycle falls below a fourth threshold duty cycle (e.g., minimum duty cycle (Dmin1)), however, the circuit requests a lower input voltage. For example, the input voltage Vin is decreased by 200 my, as shown in block 1010. Other voltage steps are also possible. From block 1010 and block 1008, the process transitions back to the starting block 1002.

A second path including blocks 1014, 1016, 1008, 1010 and 1002 is followed when it is determined that the batFET is not on. The implementation in blocks 1014, 1016, 1008, and 1010 of the first path is similar to the implementation of blocks 704, 706, 708, and 710 of FIG. 7. For example, when the batFET is not on and the duty cycle is greater than a fifth threshold duty cycle (e.g., maximum duty cycle (Dmax2)), a higher input voltage is requested. However, if the duty cycle falls below a sixth threshold duty cycle (e.g., minimum duty cycle (Dmin2)), the circuit requests a lower input voltage.

However, the threshold duty cycle values used for the condition in blocks 1014, and 1016 are different from the threshold duty cycle values used for the condition in blocks 1004, and 1006. The input voltage is regulated at different ranges of duty cycle to control the duty cycle with a narrow range for optimal efficiency and performance based on whether the batFET is on. For example, a first duty cycle range corresponds to a range defined by the second minimum duty cycle (Dmin1) and the second maximum duty cycle (Dmax1) of blocks 1004 and 1006. A second duty cycle range corresponds to a range defined by a third minimum duty cycle (Dmin2) and a third maximum duty cycle (Dmax2) of blocks 1014 and 1016. The first duty cycle range corresponding to the batFET being on is higher relative to the second duty cycle range corresponding to the batFET being off. If the duty cycle is not less than the second minimum duty cycle (Dmin1) at block 1006, the process continues to the starting block 1002. Similarly, if the duty cycle is not less than the third minimum duty cycle (Dmin2) at block 1016, the process continues to the starting block 1002.

For example, the range is adjusted higher when the batFET is on to reduce power loss. In the first case when the batFET is not on, the duty cycle regulation may be performed in a duty cycle range of 80% to 90% to maintain performance. In the second case when the batFET is on, the duty cycle regulation may be performed in a duty cycle range of 95% to 99% to maintain performance. Thus, the duty cycle range is adjusted higher when the batFET is on relative to the adjustment of the of the duty cycle range when the batFET is not on.

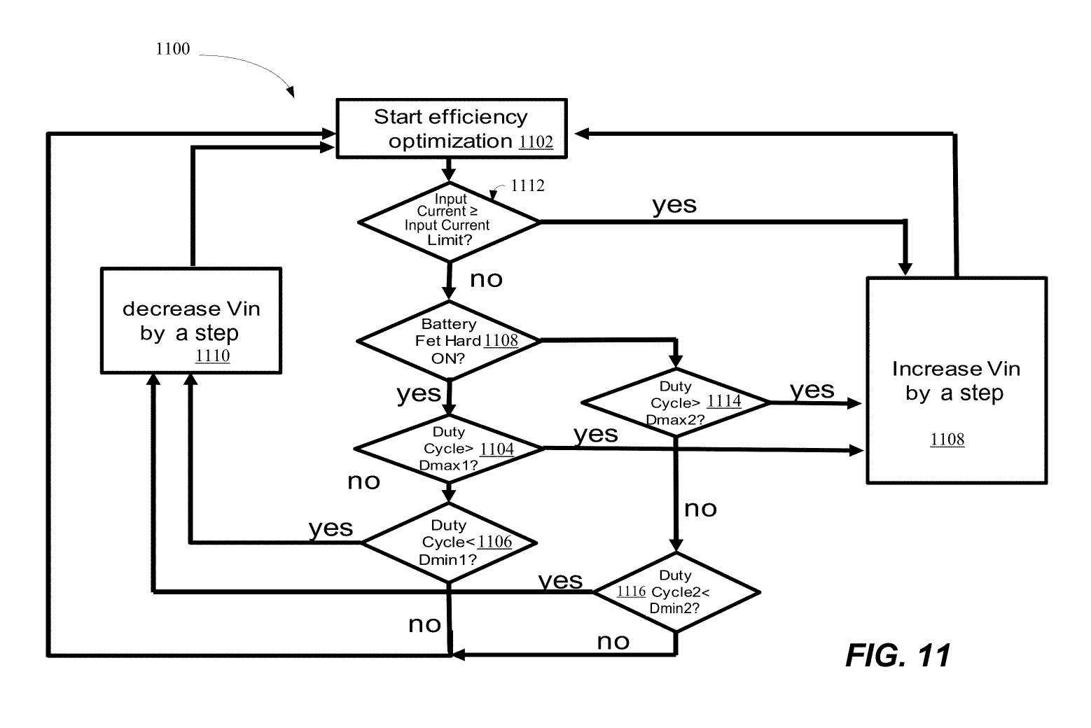

FIG. 11 shows a further duty cycle control process 1100 for minimizing or reducing power loss while maintaining performance according to aspects of the present disclosure. The duty cycle control process 1100 of FIG. 11 is similar to FIG. 10 the duty cycle control process 1000. The difference is that FIG. 11 introduces a new condition (e.g., input current limit) in addition to the conditions introduced in FIG. 10. For example, in FIG. 11, the process starts at block 1102 where the duty cycle and the input current to the switching regulator (e.g., switching regulator 520) are monitored for efficiency optimization. The input current may be monitored by an automatic input current limit circuit (e.g., automatic input current limit circuit 521). Circuits, such as duty cycle detection circuits 236, may monitor and detect the duty cycle.

The process then continues to block 1112 where it is determined whether the input current to the switching regulator is greater than or equal to an input current limit. If the input current is greater than or equal to the input current limit, a higher input voltage is requested. In this case, when the input current is too high then the input voltage is increased. An increased or higher input voltage may be requested by the controller 616. For example, the input voltage provided to the buck converter by the power device is increased by a step, as shown in block 1108.

However, if the input current is less than the input current limit, the process continues to block 1118 where it is determined whether the batFET is on. The processes at blocks 1118, 1104, 1108, 1106, 1114, 1116 and 1110 are similar to the processes in blocks 1018, 1004, 1008, 1006, 1014, 1016 and 1010 of FIG. 10.

For example, according to the illustration in FIG. 11, a circuit monitors the duty cycle of the buck converter to determine whether to adjust the input voltage based on whether the batFET is on and whether the input current limit is activated. When the input current limit is activated, a higher input voltage is requested.

When the input current limit is not activated, the batFET is on and the duty cycle is greater than the third threshold duty cycle (e.g., maximum duty cycle (Dmax1)), a higher input voltage is requested. However, if the duty cycle falls below the fourth threshold duty cycle (e.g., minimum duty cycle (Dmin1)), the circuit requests a lower input voltage. For example, Vin is decreased by 200 mv.

When the input current limit is not activated, the batFET is not on and the duty cycle is greater than the fifth threshold duty cycle (e.g., maximum duty cycle (Dmax2)), a higher input voltage is requested. However, if the duty cycle falls below the sixth threshold duty cycle (e.g., minimum duty cycle (Dmin2)), the circuit requests a lower input voltage.

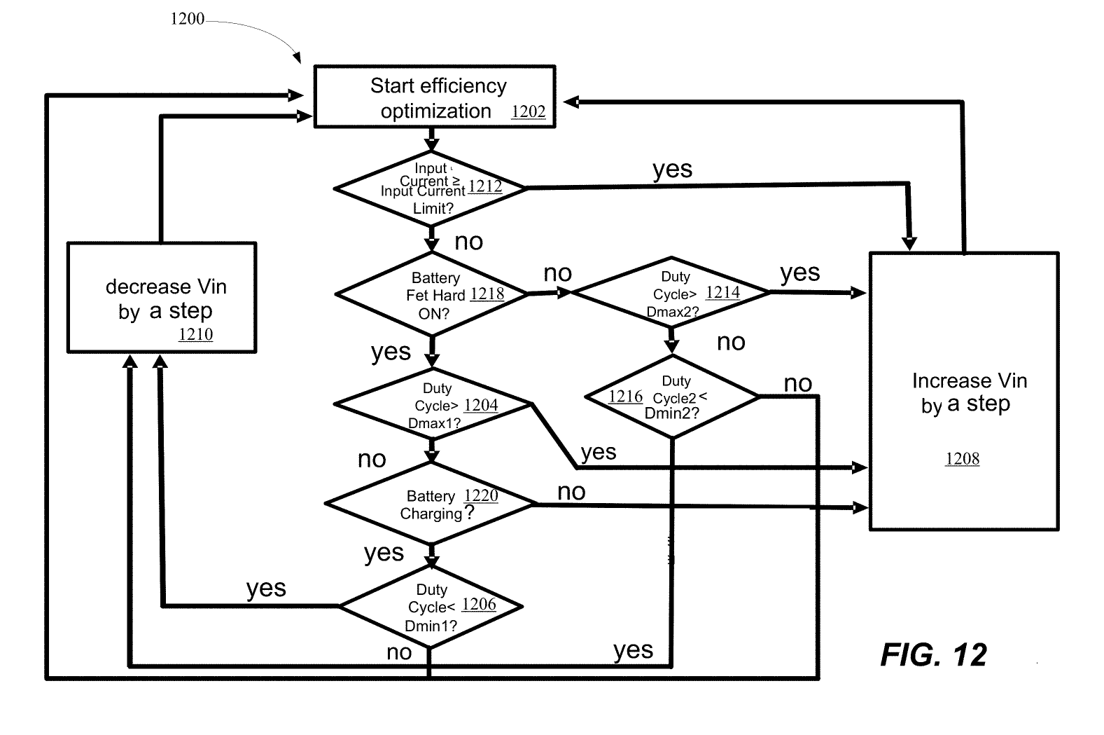

FIG. 12 shows a further duty cycle control process 1200 for minimizing or reducing power loss while maintaining performance according to aspects of the present disclosure. The duty cycle control process 1200 of FIG. 12 is similar to the duty cycle control process 1100 of FIG. 11. The difference is that FIG. 12 introduces a new condition (e.g., a battery charging condition) in addition to the conditions introduced in FIG. 11. The battery may not charge under very high duty cycle conditions. As a result, the battery charging condition is included to mitigate this issue under the high duty cycle conditions. For example, the high duty cycle conditions may correspond to the first duty cycle range, which corresponds to the range defined by the second minimum duty cycle (Dmin1) and the second maximum duty cycle (Dmax1) of blocks 1204 and 1206. For example, the processes at blocks 1202, 1204, 1206, 1208, 1210, 1212, 1214, 1216 and 1218 are similar to the processes in blocks 1102, 1104, 1106, 1108, 1110, 1112, 1114, 1116 and 1118 of FIG. 11.

The battery charging condition is introduced between blocks 1204 and 1206. For example, when the batFET is on and the duty cycle is greater than the third threshold duty cycle (e.g., maximum duty cycle (Dmax1)) as determined in block 1204, a higher input voltage is requested. However, If the duty cycle is less than or equal to the third threshold duty cycle, the process proceeds to block 1220 where it is determined whether the battery is charging. If it is determined that the battery is not charging, a higher input voltage is requested. At block 1208 the input voltage is increased.

However, if it is determined (at block 1220) that the battery is charging, the process continues to block 1206 where it is determined whether the duty cycle is less than the fourth threshold duty cycle (e.g., minimum duty cycle (Dmin1)). If the duty cycle falls below the fourth threshold duty cycle (e.g., minimum duty cycle (Dmin1)), however, the circuit requests a lower input voltage. For example, the input voltage Vin is decreased by 200 my, as shown in block 1210. Other voltage steps are also possible. From blocks 1210 and block 1208, the process transitions back to the starting block 1202. If the duty cycle does not fall below (or is not less than) the fourth threshold duty cycle (e.g., minimum duty cycle (Dmin1)), the process continues to the starting block 1202.

For example, a circuit monitors the duty cycle of the buck converter to determine whether to adjust the input voltage based on whether the batFET is on, whether the input current limit is activated, and whether the battery is charging. When the input current limit is activated, a higher input voltage is requested. When the input current limit is not activated, the batFET is on and the duty cycle is greater than the third threshold duty cycle (e.g., maximum duty cycle (Dmax1)), a higher input voltage is requested. However, if the duty cycle falls below the fourth threshold duty cycle (e.g., minimum duty cycle (Dmin1)) and the battery is charging, the circuit requests a lower input voltage.

When the input current limit is not activated, the batFET is on, the duty cycle falls below the third threshold duty cycle (e.g., maximum duty cycle (Dmax1)) and the battery is not charging, the circuit requests a higher input voltage. When the input current limit is not activated, the batFET is not on and the duty cycle is greater than the fifth threshold duty cycle (e.g., maximum duty cycle (Dmax2)), a higher input voltage is requested. However, if the duty cycle falls below the sixth threshold duty cycle (e.g., minimum duty cycle (Dmin2)), the circuit requests a lower input voltage.

The switching regulator (e.g., voltage regulator) according to aspects of the disclosure can regulate the output voltage even when the supply voltage is very close to the output voltage. A dropout voltage for the voltage regulator is the smallest difference between the input voltage and output voltage to remain inside the regulators intended range. The low drop out (LDO) circuit functions as a control loop to provide a direct current (DC)-regulated voltage, (e.g., output voltage Vout), at the load, (e.g., a load at node 561 of FIG. 5), by controlling current through the pass FET (e.g., high side switch 551 of FIG. 5). The switching regulator functions as a control loop to provide a DC-regulated voltage at the load by controlling current through the pass FET.

The performance of the switching regulator, as the dropout voltage is approached, is improved by the present disclosure. For example, as the dropout voltage is approached, there is less gain in the control loop, which may result in higher voltage deviations. The voltage deviations, however, are reduced in response to a change (e.g., increase) in the input voltage.

Aspects of the present disclosure enable user equipment (e.g., cell phones) to charge faster by reducing or even minimizing power losses.

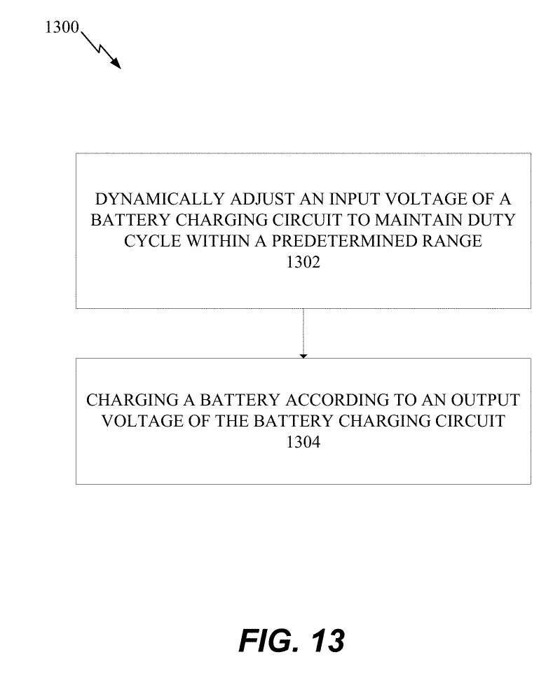

FIG. 13 shows a duty cycle control process 1300 for charging a battery in accordance with the present disclosure. At block 1302, an input voltage of a battery charging circuit is dynamically adjusted to maintain a duty cycle within a predetermined range. The battery charging circuit may adjust the input voltage by monitoring one or more input current limits, one or more transient voltages of a load, and/or the duty cycle of the battery charging circuit. The battery charging circuit then adjusts the input voltage by generating control signals to increase the input voltage when (i) the input current limit is activated, (ii) the one or more transient voltages reach a threshold voltage and/or (iii) the duty cycle reaches a threshold duty cycle. In some aspects of the disclosure, generating control signals to increase the input voltage includes generating control signals to successively increase the input voltage across voltage values until a desired charge current is obtained.

At block 1304, a battery is charged according to an output voltage of the battery charging circuit based on the dynamically adjusted input voltage. In one aspect of the present disclosure, the duty cycle is dynamically regulated to maintain an input voltage Vin approximately equal to an output voltage Vout. This may include dynamically adjusting an adapter voltage to maintain the duty cycle within a predetermined range. For example, the duty cycle may be lowered when a state of a switching regulator (e.g., a batFET) is fully on.

In one configuration, an apparatus for battery charging includes means for dynamically adjusting an input voltage of a battery charging circuit to maintain a duty cycle within a predetermined range. The dynamically adjusting means may be the control device or controller 616, the power management device 606, the voltage adjust circuitry 202 (V_adj), the power management IC 215 and/or the electronic device 510 configured to perform the aforementioned function. The apparatus for battery charging also includes means for charging a battery according to an output voltage of the battery charging circuit. In one aspect, the battery charging means may be the adapter 604, the AC power source 501a, power source 201, power adapter 102, power source 101, control device or controller 616, the power management device 606, the voltage adjust circuitry 202 (V_adj), the power management IC 215 and/or the electronic device 510 configured to perform the aforementioned function. In another aspect, the aforementioned means may be a module or any apparatus configured to perform the functions recited by the aforementioned means.

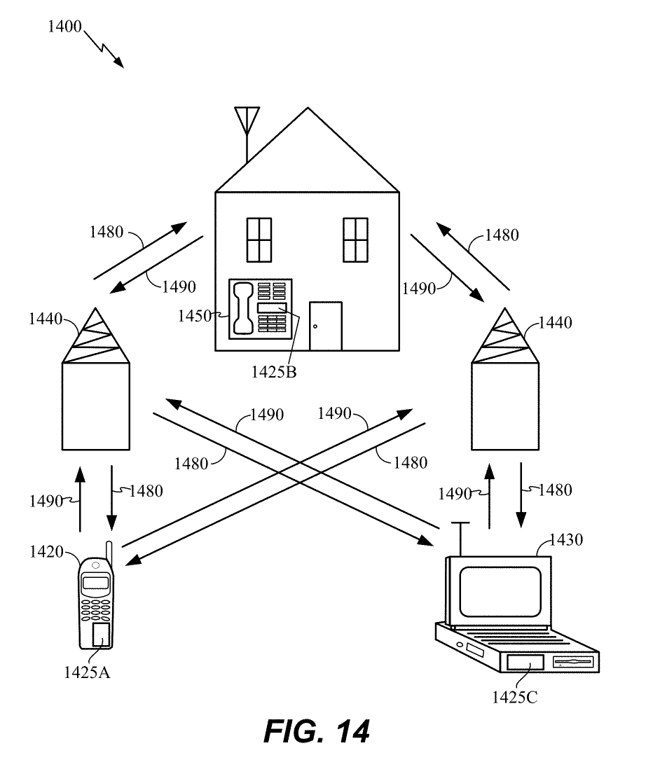

FIG. 14 is a block diagram showing an exemplary wireless communication system 1400 in which a configuration of the disclosure may be advantageously employed. For purposes of illustration, FIG. 14 shows three remote units 1420, 1430, and 1450 and two base stations 1440. It will be recognized that wireless communication systems may have many more remote units and base stations. Remote units 1420, 1430, and 1450 include charging systems 1425A, 1425B, and 1425C, which include the disclosed duty cycle control. It will be recognized that any device containing an IC may also include the disclosed duty cycle control, including the base stations, switching devices, and network equipment. FIG. 14 shows forward link signals 1480 from the base station 1440 to the remote units 1420, 1430, and 1450 and reverse link signals 1490 from the remote units 1420, 1430, and 1450 to base stations 1440.

In FIG. 14, a remote unit 1420 is shown as a mobile telephone, a remote unit 1430 is shown as a portable computer, and a remote unit 1450 is shown as a fixed location remote unit in a wireless local loop system. For example, the remote units may be a mobile phone, a hand-held personal communication systems (PCS) unit, a portable data unit such as a personal data assistant, a GPS enabled device, a navigation device, a set top box, a music player, a video player, an entertainment unit, a fixed location data unit such as a meter reading equipment, or any other device that stores or retrieves data or computer instructions, or any combination thereof. For example, a remote unit including the duty cycle control may be integrated within a vehicle control system, a server computing system or other like system specifying critical data integrity. Although FIG. 14 illustrates IC devices 1425A, 1425B, and 1425C, which include the disclosed duty cycle control, the disclosure is not limited to these exemplary illustrated units. Aspects of the present disclosure may be suitably employed in any device, which includes thermal balancing.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described herein may be implemented in hardware, software, firmware, or any combination thereof If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein=to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for battery charging, comprising:
dynamically adjusting an input voltage of a battery charging circuit to maintain a duty cycle within a predetermined range; and
charging a battery according to an output voltage of the battery charging circuit.

2. The method of claim 1, further comprising monitoring at least one input current limit and the duty cycle of the battery charging circuit.

3. The method of claim 2, in which dynamically adjusting the input voltage further comprises generating control signals to increase the input voltage when (i) the at least one input current limit is activated and/or (ii) the duty cycle reaches a first threshold duty cycle.

4. The method of claim 3, in which generating the control signals to increase the input voltage comprises generating control signals to successively increase the input voltage across a plurality of voltage values until a desired charge current is obtained.

5. The method of claim 2, in which dynamically adjusting the input voltage further comprises generating control signals to decrease the input voltage when (i) the at least one input current limit is not activated and (ii) the duty cycle fails to reach a second threshold duty cycle.

6. The method of claim 5, in which generating the control signals to decrease the input voltage comprises generating control signals to successively decrease the input voltage across a plurality of voltage values.

7. The method of claim 1, in which dynamically adjusting the input voltage comprises dynamically regulating the duty cycle to maintain the input voltage at the output voltage of the battery charging circuit.

8. The method of claim 7, further comprising lowering the duty cycle when a state of the battery charging circuit is fully on.

9. The method of claim 1, further comprising integrating the battery charging circuit into a mobile phone, a set top box, a music player, a video player, an entertainment unit, a navigation device, a computer, a hand-held personal communication systems (PCS) unit, a portable data unit, and/or a fixed location data unit.

10. An apparatus for charging a battery, comprising:
means for dynamically adjusting an input voltage of a battery charging circuit to maintain a duty cycle within a predetermined range; and
means for charging the battery according to an output voltage of the battery charging circuit.

11. The apparatus of claim 10, further comprising means for monitoring at least one input current limit and the duty cycle of the battery charging circuit.

12. The apparatus of claim 11, in which the means for dynamically adjusting the input voltage further comprises means for generating control signals to increase the input voltage when (i) the at least one input current limit is activated and/or (ii) the duty cycle reaches a first threshold duty cycle.

13. The apparatus of claim 12, in which the means for generating the control signals to increase the input voltage comprises means for generating control signals to successively increase the input voltage across a plurality of voltage values until a desired charge current is obtained.

14. The apparatus of claim 11, in which the means for dynamically adjusting the input voltage further comprises means for generating control signals to decrease the input voltage when (i) the at least one input current limit is not activated and (ii) the duty cycle fails to reach a second threshold duty cycle.

15. The apparatus of claim 14, in which the means for generating the control signals to decrease the input voltage comprises means for generating control signals to successively decrease the input voltage across a plurality of voltage values.

16. An apparatus for charging a battery, comprising:
a memory; and
at least one processor coupled to the memory and configured:
to dynamically adjust an input voltage of a battery charging circuit to maintain a duty cycle within a predetermined range; and
to charge the battery according to an output voltage of the battery charging circuit.

17. The apparatus of claim 16, in which the at least one processor is further configured to monitor at least one input current limit and the duty cycle of the battery charging circuit.

18. The apparatus of claim 17, in which the at least one processor is further configured to dynamically adjust by generating control signals to increase the input voltage when (i) the at least one input current limit is activated and/or (ii) the duty cycle reaches a first threshold duty cycle.

19. The apparatus of claim 18, in which the at least one processor is further configured to generate by generating control signals to successively increase the input voltage across a plurality of voltage values until a desired charge current is obtained.

20. The apparatus of claim 17, in which the at least one processor is further configured to dynamically adjust by generating control signals to decrease the input voltage when (i) the at least one input current limit is not activated and (ii) the duty cycle fails to reach a second threshold duty cycle.

21. The apparatus of claim 20, in which the at least one processor is further configured to generate by generating control signals to successively decrease the input voltage across a plurality of voltage values.

22. The apparatus of claim 16, in which the at least one processor is further configured to dynamically adjust by dynamically regulating the duty cycle to maintain the input voltage at the output voltage of the battery charging circuit.

23. The apparatus of claim 22, in which the at least one processor is further configured to lower the duty cycle when a state of the battery charging circuit is fully on.

24. A non-transitory computer-readable medium having program code recorded thereon, the program code comprising:
program code to dynamically adjust an input voltage of a battery charging circuit to maintain a duty cycle within a predetermined range; and
program code to charge a battery according to an output voltage of the battery charging circuit.

25. The computer-readable medium of claim 24, further comprising program code to monitor at least one input current limit and the duty cycle of the battery charging circuit.

26. The computer-readable medium of claim 25, further comprising program code to dynamically adjust by generating control signals to increase the input voltage when (i) the at least one input current limit is activated and/or (ii) the duty cycle reaches a first threshold duty cycle.

27. The computer-readable medium of claim 26, further comprising program code to generate control signals to successively increase the input voltage across a plurality of voltage values until a desired charge current is obtained.

28. The computer-readable medium of claim 25, further comprising program code to dynamically adjust by generating control signals to decrease the input voltage when (i) the at least one input current limit is not activated and (ii) the duty cycle fails to reach a second threshold duty cycle.

29. The computer-readable medium of claim 28, further comprising program code to generate by generating control signals to successively decrease the input voltage across a plurality of voltage values.

30. The computer-readable medium of claim 24, further comprising program code to dynamically adjust by dynamically regulating the duty cycle to maintain the input voltage at the output voltage of the battery charging circuit.
